(19) United States
(12) Patent Application Publication
(10) Pub. No.: US 2005/0235000 A1
(43) Pub. Date: Oct. 20, 2005

(54) Aaa server system for efficient control and address assignment

(76) Inventor: Wolfgang Keil, Munchen (JP)

Correspondence Address: Siemens Corporation;Intellectual Property Department, 170 Wood Avenue South, Iselin, NJ, 08830, US

(21) Appl. No.: 10/509,286

(22) PCT Filed: Mar. 18, 2003
(86) PCT No.: PCT/DE03/00895

§ 371 Date: Sep. 23, 2004

(30) Foreign Application Priority Data
Mar. 27, 2002 (DE) 10213862.1

(51) Int. Cl. G06F 12/00

(52) U.S. Cl. 707/200

(57) ABSTRACT

The invention relates to an AAA (Authentication, Authorization, Accounting) server system (RADSS) for managing a pool (A) of logical addresses (IP1, . . . , IPN) and a method for updating status information within the AAA server system (RADSS). Said AAA server system (RADSS) comprises several AAA servers (RAD1, RAD2, RAD3). Each of the AAA servers (RAD1, RAD2, RAD3) are assigned one or more discrete partial amounts (A1, A2, A3) of the address pool (A). Status information exchanged relating to address allocation affect the discrete partial amounts (A1, A2, A3) of addresses. The invention has the advantage of a low-complexity and efficient message exchange between the AAA servers (RAD1, RAD2, RAD3). An efficient allocation of resources to logical addresses is guaranteed as a result of changes to the assignment of partial amounts (A1, A2, A3) of logical addresses (IP1, . . . , IPN) in AAA servers (RAD1, RAD2, RAD3), according to need.

The invention relates to an AAA (Authentification, Authorization, Accounting) server system and a method for the administration of a pool of logical addresses.

The logical addressing of subscribers or hosts and the administration of the available address space for networks and in the Internet is an important functional area of network technology. The hardware required for the administration of logical addresses and to provide the appropriate functionality for issuing addresses often takes the form of AAA (Authentification, Authorization, Accounting) servers, or AAA server systems. For address administration by multi-server systems, information about the issuing of addresses, and about the resources which are available, together with items of status information, must be exchanged between the individual servers in a reliable manner and at a high data transmission rate.

When subscribers dial into the Internet, e.g. using either conventional narrowband telephone lines or xDSL technology (DSL: Digital Subscriber Line), access to the Internet is normally controlled by AAA servers using the RADIUS (Remote Authentification Dial-In User Service) protocol, which are therefore called RADIUS servers. This is where the interface is effected from the telephone network to the Internet or an IP network, as applicable, at an access server which for the Internet is designated the Network Access Server (NAS). Before a connection can be established for a subscriber, messages are exchanged between the NAS and the RADIUS server, using the RADIUS protocol, to initiate checks in the RADIUS server on the identity and access rights of the subscriber. If the reply from the RADIUS server is positive, i.e. the subscriber is authorized, the NAS establishes a connection between the IP network and the subscriber or his Internet terminal device, as applicable. In doing this, the Internet terminal device must have a unique routable IP address. As the supply of available IP addresses is restricted, most Internet service providers—referred to below as ISPs—issue IP addresses to their customers, i.e. subscribers, only for the duration of the Internet connection. During different Internet sessions the subscriber or his Internet terminal device, as applicable, is thus assigned different Internet addresses. Usually there is an IP address range—referred to below as an address pool—available to the Internet Service Provider, from which addresses can be taken for temporary assignment to subscribers. One Internet Service Provider can also have several address pools available, for example in order to be able to form several service groups for different services.

Dynamic assignment of IP addresses is usually effected either in the access server or NAS, or alternatively in the AAA server or RADIUS server. Assigning IP addresses in the access servers or NAS has the disadvantage of a considerable administration and maintenance effort for Internet Service Providers who operate a large number of access servers. Address pools must be set up in each individual access server. For major Internet Service Providers, the number of access servers to be supplied is considerable, and consequently there is substantial expense in setting up and changing address pools. In addition, there is no central control of the current Internet connections, and the IP addresses they are using. For example, for the operators of access networks who rent access on to smaller Internet Service Providers, central administration and issuing of the available address pool is of major importance.

In the case of major Internet Service Providers it is therefore usual for the resource administration, and hence also the administration of the IP addresses, to be carried out centrally by one or more high-performance and high-availability AAA servers. In this connection, the term “high performance” means the ability to process a large number of access checks per second.

A common implementation of a high performance central controller is by means of a multi-server system. In general, this consists of a number of individual computers or servers, as appropriate, which are linked to each other by means of the IP network. This is a low-cost solution, because it requires no expensive fail-safe hardware or cluster software. In addition, it is easy to scale the system up by the incorporation of further computers. On grounds of redundancy, to give fail-safety, the individual computers should be in a position to undertake the tasks of other computers in the multi-server system. The distribution of the load to the various computers in the multi-server system is effected, for example, by the RADIUS clients on the access servers.

For the purpose of administration of the IP addresses by a multi-server system, information about the issue of addresses, the demand for addresses, and status information about ongoing and completed Internet sessions, must be collected and made available to the individual computers. Because of the redundancy requirements, the data which is available to an individual computer should also be accessible to at least one other individual computer. In addition, it is necessary to ensure that addresses are not issued more than once, by different individual computers.

These requirements for the administration of IP addresses by a multi-server system can be satisfied, for example, by IP addresses being supplied to the individual computers in the multi-server by a central server, e.g. a DHCP (Dynamic Host Configuration Protocol), or by a server which works using vendor-specific protocols. This solution has the following disadvantages:
Protection of the central computer against failures, e.g. by duplication, is generally associated with considerable expense.
For reliable communication between the central server and the other computers in the multi-server system, the messages which are exchanged should be acknowledged. This causes the volume of data which must be processed to increase sharply with the number of computers. This has a detrimental effect on the scalability, that is the integration of further computers into the multi-server system.
An increase in the number of connection requests leads to an increase in the data traffic between the central server and the individual computers. As a result, load peaks (bursts) can occur, and these can cause delays in the processing.
The central server often results in additional maintenance costs.

For the purpose of raising the fail-safety, there is the possibility of using an enhanced RADIUS protocol to save status information directly on the access servers or NAS, as applicable. This solution is documented in RFC (Request for Comments) 2882, but will only function for access servers which support the appropriate protocol enhancement.

Alternatively, the entire set of data about address pools can be saved on each of the computers in the multi-server system, and messages exchanged between the individual computers to coordinate the address reservations. This approach results in a substantial volume of messages to be exchanged if duplicate issuing of addresses is to be avoided.

The object of the invention is to specify efficient administration of one or more address ranges in an AAA server system, which avoids the disadvantages of the conventional methods.

This object is achieved by an AAA server system in accordance with claim 1 and a method in accordance with claim 10.

The AAA server system in accordance with the invention incorporates numerous AAA servers for the administration of at least one pool of logical addresses. Here, each of several disjoint subsets or subpools, as applicable, of at least one address pool is assigned to exactly one AAA server. Only the AAA server to which they belong can assign the logical addresses in each of the subsets of the address pool to a terminal device or subscriber, and they are administered by that AAA server (claim 1). It is also possible for a number of subsets of an address pool to be assigned to one AAA server. The address pools can be, for example, IP address ranges (claim 2). The assignment of addresses to terminal devices by the AAA servers in the AAA server system can be made, for example, with the help of the RADIUS (Remote Authentication Dial-In User Service) protocol (claim 3). These protocols are often used for communication between an AAA server system and an access server or NAS, with the help of which terminal devices can be connected to the network (e.g. Internet). The AAA servers of the AAA server system can, for example, communicate with each other using the Internet protocol or TCP/IP (Transmission Control Protocol/Internet Protocol) (claims 4 and 8). For the purpose of changing the assignment of subsets of logical addresses, or subpools of logical addresses, to AAA servers, it is logical if all the AAA servers of the server system have available the entire pool or entire pools of logical addresses, as applicable (claim 5).

The subdivision of the available address space into subsets and the assignment of these subsets to AAA servers permits the effort of communicating between the individual servers or computers, as applicable, to be reduced.

With the method in accordance with the invention for the updating of information in an AAA server system in accordance with the invention, a first AAA server in the server system sends an updating message regularly to all the other servers in the AAA server system. This updating message comprises information about changes in the status of subsets of the address pool or address pools assigned to the first AAA server, which have occurred since the previous available update. The regular sending, for example at fixed intervals of time, of updating messages from the AAA server to all the other AAA servers in the AAA server system enables the issuing of logical addresses by the individual AAA servers in the AAA server system to be coordinated. In this way, the subsets of the address pool or address pools which are in use can be signaled to all the AAA servers. In addition, information can be exchanged between the AAA servers about the logical address resources which will be required during the coming time interval. This involves an AAA server, before sending its updating message, in estimating the number of logical addresses to be issued in the time period between the updating message which is being sent and the next-following updating message. This can be done by forming the product of the maximum rate at which the AAA server can process requests for the issue of a logical address and the time period between the updating message which is being sent and the next-following updating message (claim 12). The estimate thus obtained provides an upper limit for the number of addresses which will be required. From the subsets of the address pool which are assigned to the server, some are selected from which to take the logical addresses which will, according to the estimate, be required in the time period. The updating message can then contain information about which of the subsets of the address pool, assigned to the AAA server, have been selected from which to take the logical addresses which, according to the estimate, will be required in the time period (claim 11). In this way, subsets of logical addresses can be marked as “uncertain”, i.e. it is possible that logical addresses may be issued from these subsets within the next time period. This marking comes into play if individual AAA servers require additional subsets of the address pool in order to satisfy connection requests. In such a case, the responsibility for or assignment of subsets of the address pool which are not marked as “uncertain” can be changed, and assigned to the AAA server which has a shortage of logical addresses (claim 13). With this method, the individual AAA servers communicate a mixture of redundant data and blocking information (marked subsets of the address pool, the assignment of which may not be reallocated). This limits the volume of data which must be exchanged between the servers. As a general rule, individual servers will not be able to see which individual addresses have been issued by other AAA servers. This reduces the status information which must be stored on the individual computers—for other AAA servers, status details will be maintained for the subsets (possibly indexed) rather than for the individual addresses—and the data transmission rate for the information exchange between the servers is reduced.

If an AAA server should fail, the subsets of the address pool which are assigned to this AAA server can be assigned to another AAA server, e.g. in accordance with the stipulations of a priority list (claims 14 and 15). The subsets for the AAA server which has failed may if necessary also be distributed between several other AAA servers. It is then logical that those subsets of logical addresses which were marked as “uncertain” in the last updating message received from the server which has failed should for a certain period of time remain unused when making a new issue of logical addresses (claim 16). This period of time could, for example, correspond to the maximum permitted connection time (claim 17). Updating messages can also be used when rebooting AAA servers in the AAA server system. For example, a rebooted AAA server would send a multicasting message to the other AAA servers, in which it requests the sending of updating messages and the assignment of subsets of the address pool (claim 18). In communicating the updating message, the TCP/IP protocol, the RADIUS protocol or the DIAMETER protocol could be used as the transport protocol. As a result of the reduction in the volume of messages exchanged, it is possible that the individual servers of the server system could be installed at different places, i.e. locally (claim 9).

Further advantageous developments of the subject of this invention are specified in the other subclaims.

The invention is explained in more detail below in the context of an exemplary embodiment by reference to five figures. These show:

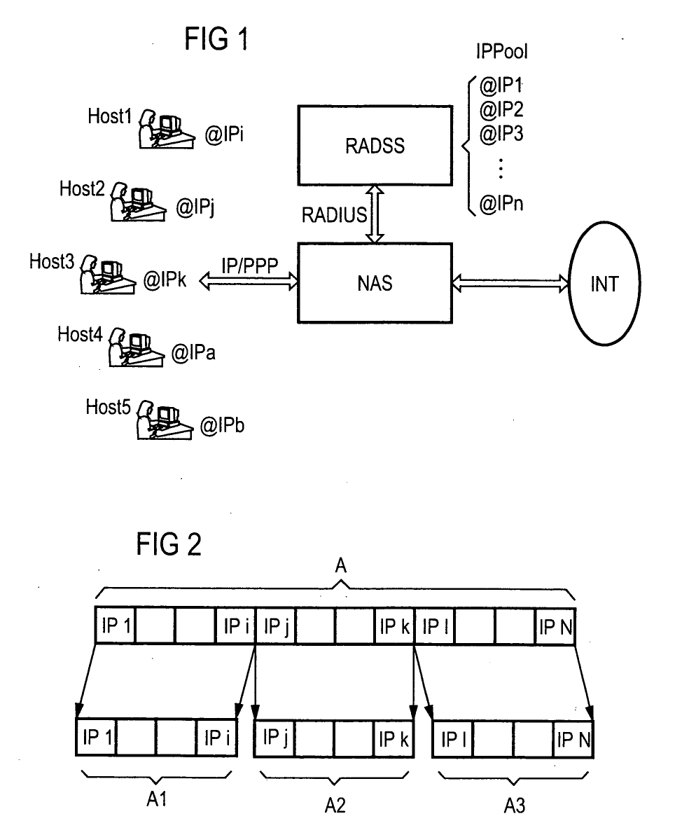

FIG. 1: A scenario for the dynamic assignment of addresses for Internet sessions.

FIG. 2: The subdivision of an address range or address pool into subsets or subpools respectively.

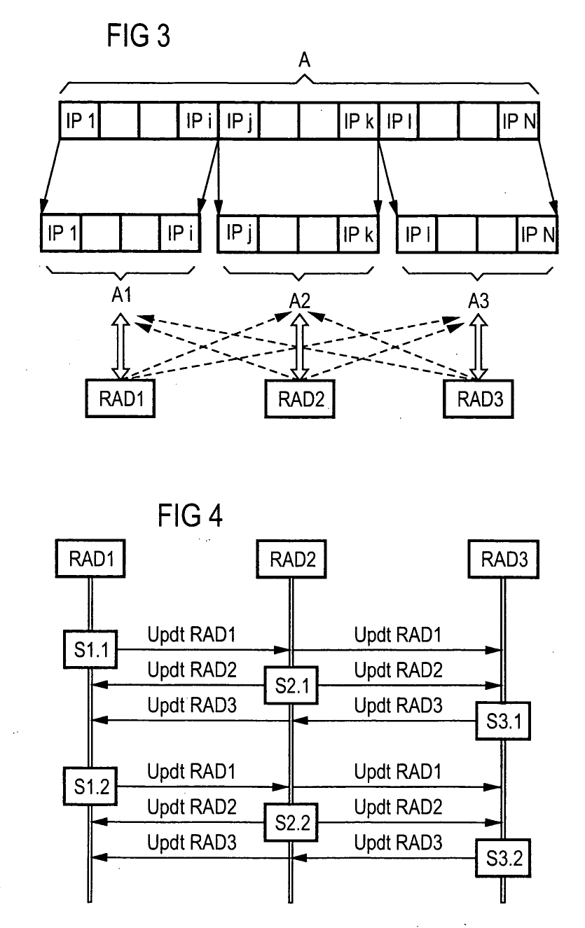

FIG. 3: The assignment of subsets of logical addresses to RADIUS servers.

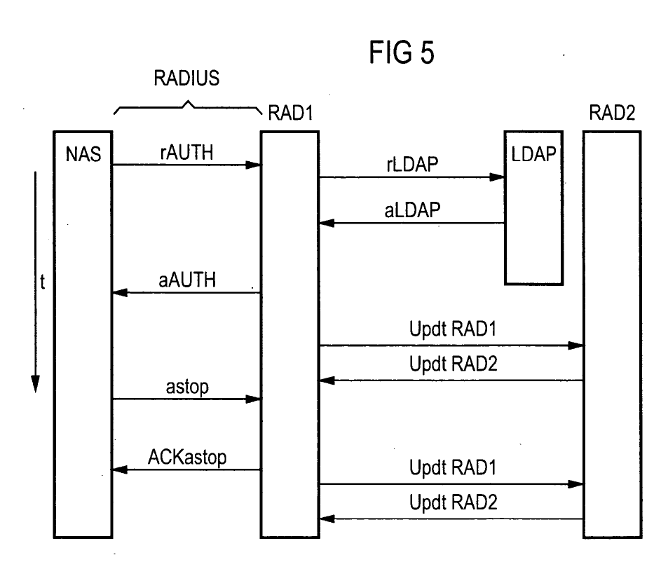

FIG. 4: The exchange of updating messages between three RADIUS servers.

FIG. 5: The various steps in a request for an additional subset of logical addresses.

In the context of the exemplary embodiment it is assumed that one or more IP address ranges are administered by a RADIUS server system, i.e. a multi-server system which works by means of the RADIUS protocol. The RADIUS server system consists of several RADIUS servers which are linked together by means of a network. No special software, e.g. cluster software, is required. For the sake of simplicity it is assumed that, for the exemplary embodiment, an address pool corresponds to an IP address range, and subsets of the address pool to subranges of IP addresses. A global address range or address pool, as applicable, can be assigned to an Internet Service Provider, or reserved for certain service classes.

FIG. 1 shows Internet terminal devices Host1, . . . , Host5, via which the subscribers can establish a connection to the Internet INT. With the help of the IP (Internet Protocol), which runs via the PPP (Point-to-Point Protocol), a connection can be established between the terminal device Host1 . . . Host5 and an access server NAS. Before the access server establishes a connection to the Internet INT, a request is processed by the RADIUS server system RADSS. The exchange of messages between the access server NAS and the RADIUS server system RADSS is effected with the help of the Radius protocol RADIUS. The RADIUS server system provides a pool IPPool of separate IP addresses @IP1, . . . , @IPn, which are assigned dynamically to the Internet terminal devices Host1, . . . , Hostn for the duration of the connection. After the RADIUS server system has received the authorization message, and an IP address has been allocated for the duration of the call, the access server NAS establishes an Internet connection for the requesting Internet terminal device Host1, . . . , Host5.

FIG. 2 shows an address pool A, consisting of the address range IP 1 to IP N. This address pool A is subdivided into three subsets A1, . . . , A3, corresponding to the address subranges IP 1 to IP I, IP J to IP K and IP L to IP N. Each of the RADIUS servers can release IP addresses from any desired subset A1, . . . , A3 of IP addresses. On the other hand, the right to assign IP addresses for connections is exclusive, i.e. each RADIUS server is assigned one or more subsets A1, . . . , A3 of addresses, from which it can issue IP addresses. This right to issue IP addresses can be moved around dynamically between the RADIUS servers. FIG. 3 shows three RADIUS servers, RAD1, . . . , RAD3. Each is assigned a subrange of addresses A1, . . . , A3 (indicated by the unbroken arrows), from which it can assign addresses. All three RADIUS servers can release used addresses, this being indicated by the dashed arrows.

FIG. 4 shows how the updating of information about the status of other RADIUS servers is undertaken by an individual RADIUS server. At regular intervals of time, each RADIUS server, RAD1, . . . , RAD3, sends an updating message to all the other RADIUS servers, RAD1, . . . , RAD3, to inform them of changes relating to the assigned subsets of addresses. This updating message is sent with the help of an IP multicasting mechanism, and relates only to subsets for which there has been a change since the last updating message. Updating messages are not acknowledged. Duplicated issuing of IP addresses is excluded because, in the worst case, information about a release will be lost, i.e. details of an IP address which has already been used. The release will then take place later, after the timer for the maximum issue time has expired. The updating message contains in addition information about the subsets of addresses from which IP addresses will be issued in the following time interval. The subsets concerned are those in which IP addresses are available which have not yet been issued. As in FIG. 4, the RADIUS server RAD1 sends updating messages UpdtRAD1 (for: update for RAD1) to the RADIUS servers RAD2 and RAD3 at the time points S1.1 and S1.2. At different time points S2.1 and S2.2, and S3.1 and S3.2, respectively, each of the RADIUS servers RAD2 and RAD3 sends updating messages UpdtRAD2 and UpdtRAD3 respectively to the other RADIUS servers, RAD1 and RAD3 or RAD1 and RAD2 respectively.

The following information relating to the entire or global address pool A is saved on each of the RADIUS servers RAD1, . . . , RAD3:
An identifier for the global address pool A, for the case when several global address pools are used, for example for different service classes.
A list of the RADIUS servers RAD1, . . . , RAD3, which can access the addresses in the global address pool A. This list contains the IP address of each RADIUS server RAD1, . . . , RAD3, an identifier for each RADIUS server RAD1, . . . , RAD3, the time point for the last update for each RADIUS server RAD1, . . . , RAD3, and the total number of IP addresses which are currently free, i.e. unissued.
The first IP address of the global address range A.
The number of IP addresses which belong in this address range A.
The time interval between successive updates.
The maximum duration of Internet device connection that is provided for.
A list of the subsets of IP addresses, for example in the form of pointers, each of which points to the first IP address in the subrange.
Optionally, a list of access servers or port identifiers. This list contains all the linked NASs in the form of their IP addresses or their NAS codes and their port numbers.
For a global address pool A, a flag can be defined in addition, which indicates a shortage of IP addresses. This flag will be set, for example, if the total number of free IP addresses is less than a threshold, for example the time interval between updates multiplied by the maximum rate of requests for IP addresses. The setting of this flag will be cancelled if the number of free addresses goes above the threshold again.

The following information relating to the subsets of addresses is stored on all the RADIUS servers:
The identifier of the RADIUS server which is responsible for the subset of addresses, i.e. the AAA server which can issue IP addresses from this subset.
The first IP address in the subset or subrange of IP addresses.
The number of IP addresses in the subset.

The details held on the AAA RADIUS servers, relating to the subsets of addresses, will be updated at regular time intervals. Updating will be initiated by the expiry of a timer, which measures the time interval between two updating messages. The RADIUS server which is sending out the updating message concerning the status of its subsets of addresses determines those addresses from its assigned subsets of addresses which are free, i.e. unissued, and identifies the subsets which may be considered for use during the next time interval. The updating message then includes the code of the Radius server which is sending the message, the total number of free IP addresses for this RADIUS server, the codes or identifiers of the subsets of addresses which may be considered for use during the next time interval, i.e. which are marked as “uncertain”, changes in respect of the use of subsets since the last updating message and, if appropriate, further status information. After the updating message has been sent, the timer is restarted. A RADIUS server which receives an updating message will reset a monitoring timer which measures how much time has elapsed since the last updating message. By reference to the updating message it has received, the RADIUS server updates the status details for the Radius server which sent the message.

FIG. 5 shows the exchange of messages about and during the connection of a subscriber or terminal device, as applicable. To connect an Internet terminal device, an NAS (Network Access Server) uses the Radius protocol RADIUS to direct an authentification request rAUTH to a RADIUS server RAD1. This authentification request rAUTH contains the code of the NAS, the identifier of the port and the code of the subscriber or terminal device. The RADIUS server RAD1 submits a request rLDAP to an LDAP (Lightweight Directory Access Protocol) database, in the course of which the code or identity of the subscriber, as applicable, is determined. In its reply aLDAP, the LDAP database LDAP supplies the code for the subset of addresses from which the IP address is to be taken. An IP address is then determined from this subset of IP addresses. After this, the RADIUS server informs the NAS of the IP address which has been determined, in a reply AAUTH to the authentification request. The fact of this new connection is notified to the other Radius servers RAD2 in the course of an updating message UpdtRAD1, e.g. in the form of an updated total number for the IP addresses used and, if appropriate, by the appropriate subset of addresses being re-marked as “uncertain”. In an analogous way, during its connection the Radius server RAD1 receives updating messages UpdtRAD2 from other Radius servers RAD2. If the connection is to be terminated, the NAS sends an ‘astop’ message to the RADIUS server, to terminate the billing or accounting for the corresponding connection. This message contains the code of the subscriber and the assigned IP address. The RADIUS server RAD1 acknowledges this message by an ACKstop acknowledgement message to the NAS, which again contains the code for the subscriber and the IP address used. After the connection has been terminated, the other Radius servers RAD2 are supplied with the corresponding updated status details in the subsequent updating message UpdtRAD1.

If the RADIUS server does not have available enough subsets of addresses for the requests by access servers or NASs, as applicable, it can request the assignment of further subsets of IP addresses. A query or request of this type, as appropriate, is initiated if the RADIUS server's total number of free IP addresses falls below a threshold which is given, for example, by the product of the time interval between the updating messages and the maximum rate at which connection requests can be processed. In this case, the RADIUS server will set a flag, which indicates the shortage of IP addresses. By reference to the status information for the other RADIUS servers, the RADIUS server checks which server has the greatest number of free IP addresses or the greatest number of unmarked or unused subsets of addresses, as applicable. If it is possible to identify a RADIUS server which has available substantially more free addresses than the threshold value for a shortage of IP addresses, the RADIUS server with an address shortage will send a request for the assignment of a further subset of addresses. When this message is sent, a monitoring timer is set. If a negative reply is received, the RADIUS server with the address shortage sends an appropriate request to other RADIUS servers, according to the volume of their free addresses. If it is not possible to identify a RADIUS server with free addresses, or if no reply is received from the RADIUS servers, the RADIUS server which has the shortage of addresses will wait at least for one updating interval before repeating its request. If all the free IP addresses are issued over this period, additional authentification requests will be rejected by the NAS. On the other hand, if a positive reply is received to the request for a new subset of addresses, then this positive reply will be notified to all the other RADIUS servers by means of a multicast, and internally all the relevant data will be updated. This mechanism can also be used for the automatic reconfiguration of a RADIUS server after it is rebooted.

In the case of a failure of a RADIUS server, a hierarchy of responsibilities will be prescribed by a list of the codes of the RADIUS servers. After the point when no more updating messages are received from the RADIUS server which has failed, the RADIUS server at the top of the hierarchy, or the next RADIUS server after that, will take over the control or administration of the appropriate IP address ranges. In this process, the following steps are executed in the RADIUS server which takes over the administration of the subsets of addresses:

The take-over of the addresses is initiated by the expiry of the monitoring timer. After this, a request is sent to the RADIUS server which has failed for an updating message. If no reply is received to this, a multicast message is used to inform all the other RADIUS servers that the RADIUS server which is sending the multicast message is taking over the administration and assignment of the subsets of addresses belonging to the RADIUS server which has failed. The subsets of addresses belonging to the RADIUS server which is taking over is extended by the subsets which have been taken over. In doing this, those subsets which are marked as “uncertain” will be blocked, and a timer will be started for this blocking. This timer measures the maximum time for which an IP address may be assigned to a connection. On expiry of the timer, the block will be removed from the subsets of addresses. Now, all the IP address resources are once more available, and the failure of the RADIUS server is completely compensated.

1. Method for updating information in an AAA server system, whereby
an updating message (UpdtRAD1, UpdtRAD2, UpdtRAD3) is sent regularly by a first AAA server (RAD1, RAD2, RAD3) of the AAA server system (RADSS) to all the other AAA servers (RAD1, RAD2, RAD3) of the AAA server system (RADSS),
this updating message (UpdtRAD1, UpdtRAD2, UpdtRAD3) incorporates information about changes to the status of the subsets (A1, A2, A3) of the address pool (A) which are assigned to the first AAA server (RAD1, RAD2, RAD3), which have taken place since the previous updating message (UpdtRAD1, UpdtRAD2, UpdtRAD3)
before the updating message (UpdtRAD1, UpdtRAD2, UpdtRAD3) is sent, an estimate is made in the first AAA server (RAD1, RAD2, RAD3) of the logical addresses which will be issued in the time period between the updating message which is about to be sent (UpdtRAD1, UpdtRAD2, UpdtRAD3) and the next-following updating message (UpdtRAD1, UpdtRAD2, UpdtRAD3),
subsets (A1, A2, A3) of the address pool (A), which are assigned to the first AAA server (RAD1, RAD2, RAD3), are selected from which to take the logical addresses which, according to the estimate, will be required in the time period, and
the updating message (UpdtRAD1, UpdtRAD2, UpdtRAD3) also contains information about which of the subsets (A1, A2, A3) of the address pool (A), which are assigned to the first AAA server (RAD1, RAD2, RAD3), have been selected from which to take the logical addresses which, according to the estimate, will be required in the time period.

2. Method in accordance with claim 1,
characterized in that
the estimate is made by forming the product of the maximum rate at which the AAA server (RAD1, RAD2, RAD3) can process requests for the issue of a logical address and the time period between the updating message (UpdtRAD1, UpdtRAD2, UpdtRAD3) which is about to be sent and the next-following updating message (UpdtRAD1, UpdtRAD2, UpdtRAD3).

3. Method in accordance with one of the claims 1 or 2,
characterized in that
the first AAA server (RAD1, RAD2, RAD3) checks whether the subsets (A1, A2, A3) of the address pool (A) which will be required according to the estimate are available, and
if the result of the check by the first AAA server (RAD1, RAD2, RAD3) is negative, the assignment of a subset from another AAA server (RAD1, RAD2, RAD3) to the first AAA server (RAD1, RAD2, RAD3) is effected.

4. Method in accordance with one of the claims 1 or 2,
characterized in that
in the event of the failure of the first AAA server (RAD1, RAD2, RAD3), the subsets (A1, A2, A3) of the address pool (A) which are assigned to the first AAA server (RAD1, RAD2, RAD3) are assigned to a second AAA server (RAD1, RAD2, RAD3).

5. Method in accordance with claim 4,
characterized in that
the second AAA server (RAD1, RAD2, RAD3) is selected in accordance with the stipulations of a priority list of AAA servers (RAD1, RAD2, RAD3).

6. Method in accordance with claim 1 and one of the claims 4 or 5,
characterized in that
if a first AAA server (RAD1, RAD2, RAD3) fails the subsets (A1, A2, A3) of the address pool (A), which according to the last updating message received by the second AAA server (RAD1, RAD2, RAD3) from the first AAA server (RAD1, RAD2, RAD3) have been selected from which to take the logical addresses which according to the estimate will be required in the time period, will not be used for the reissuing of logical addresses (IP1, . . . , IPN) for a period of time.

7. Method in accordance with claim 6,
characterized in that
the time period will be determined in accordance with the stipulations for the maximum permissible connection time.

8. Method in accordance with one of the preceding claims,
characterized in that
a second AAA server (RAD1, RAD2, RAD3) is rebooted, and
the second AAA server (RAD1, RAD2, RAD3) transmits a multicast message to all the other AAA servers (RAD1, RAD2, RAD3) of the AAA server system (RADSS), by which it requests the dispatch of updating messages (UpdtRAD1, UpdtRAD2, UpdtRAD3) and the assignment of subsets (A1, A2, A3) of the address pool (A) to the first AAA server (RAD1, RAD2, RAD3).

9. Method in accordance with one of the preceding claims,
characterized in that
the TCP/IP protocol, the RADIUS protocol or the DIAMETER protocol is used as the transport protocol for the communication of updating messages (UpdtRAD1, UpdtRAD2, UpdtRAD3).
